(19) United States
(12) Patent Application Publication
(10) Pub. No.: US 2024/0294126 A1
(43) Pub. Date: Sep. 5, 2024

(54) WIRE HARNESS MOUNTING STRUCTURE

(71) Applicant: YAZAKI CORPORATION, Tokyo (JP)

(72) Inventor: Youngho JANG, Aichi (JP)

(73) Assignee: YAZAKI CORPORATION, Tokyo (JP)

(21) Appl. No.: 18/592,599

(22) Filed: Mar. 1, 2024

(30) Foreign Application Priority Data
Mar. 2, 2023 (JP) 2023-031746

(51) Int. Cl. B60R 16/02; H02G 3/32

(52) U.S. Cl. CPC B60R 16/0215; H02G 3/32

(57) ABSTRACT

A wire harness mounting structure includes: a clamp including a body part, an engaging part, and a supporting part; and a mounting part having a through hole. The supporting part is smaller than the engaging part as viewed in a height direction along a facing direction of the body part and the engaging part. The through hole includes: a first through hole larger than the engaging part as viewed in the height direction; a second through hole that is continuous with the first through hole and is smaller than the engaging part and is larger than the supporting part as viewed in the height direction; and an elastic piece that is arranged in the first through hole. The second through hole has a shape in which only the supporting part enters therein when the engaging part enters the first through hole while deforming the elastic piece.

### CROSS-REFERENCE TO RELATED APPLICATION

The present application is based on, and claims priority from the Japanese Patent Application No. 2023-031746, filed on Mar. 2, 2023, the entire contents of which are incorporated herein by reference.

### TECHNICAL FIELD

The disclosure relates to a wire harness mounting structure.

### BACKGROUND

Conventionally, various wire harnesses are wired inside a vehicle such as an automobile. JP 2002-71053 A discloses a technology of a structure for mounting a wire harness in a vehicle via a clamp having a blade part that functions as what is referred to as snap-fastening. A hole for clamp connection is disposed in advance in any one of walls of the vehicle, and the blade part is pushed into the hole and deformed, and then passes through the wall and a shape thereof returns to an original shape, and accordingly the clamp is engaged with the hole.

### SUMMARY OF THE INVENTION

In the structure disclosed in JP 2002-71053 A, since the clamp is connected to a wall in the vehicle by means of elastic deformation of the blade part, what is referred to as a half-engagement state may occur depending on the degree in which the blade part is pushed into the hole, and thereafter the clamp may be detached from the hole. If the clamp is detached from the hole, the wire harness wired via the clamp will be detached from a prescribed installation position, which is undesirable.

An object of the present disclosure is to provide a wire harness mounting structure that makes it difficult to detach a wire harness from a prescribed installation position.

A wire harness mounting structure according to some embodiments includes: a clamp including a body part for holding a wire harness, an engaging part facing to at least a portion of the body part, and a supporting part that protrudes from the body part and supports the engaging part; and a mounting part having a through hole with which the engaging part is engaged, in which the supporting part is smaller than the engaging part as viewed in a height direction along a facing direction of the body part and the engaging part, the through hole includes: a first through hole larger than the engaging part as viewed in the height direction; a second through hole that is continuous with the first through hole and is smaller than the engaging part and is larger than the supporting part as viewed in the height direction; and an elastic piece that is arranged in the first through hole and is supported by an opening edge with a side facing the second through hole as a free end and a side opposite to the side facing the second through hole as a fixed end, and the second through hole has a shape in which only the supporting part enters therein when the engaging part enters the first through hole while deforming the elastic piece.

According to the above configuration, it is possible to provide a wire harness mounting structure that makes it difficult to detach a wire harness from a prescribed installation position.

### BRIEF DESCRIPTION OF DRAWINGS

FIG. 1 is a perspective view of a wire harness mounting structure according to an embodiment.

FIG. 2A is a perspective view of a clamp.

FIG. 2B is a side view of the clamp as viewed in a length direction.

FIG. 3A is a partial plan view of a protector as viewed in an engagement direction of an engaging part.

FIG. 3B is a partial cross-sectional view of the protector which is taken along cross section IIIB-IIIB in FIG. 3A

FIG. 4 is a cross-sectional view illustrating a state of the wire harness mounting structure during a mounting operation.

FIG. 5A is a cross-sectional view of the mounting structure which is taken along cross section VA-VA in FIG. 1

FIG. 5B is a cross-sectional view of the mounting structure which is taken along cross section VB-VB in FIG. 5A.

FIG. 6 is a side view of a clamp having an engaging part as a first modified example.

FIG. 7 is a perspective view of a clamp having an engaging part as a second modified example.

### DETAILED DESCRIPTION OF THE INVENTION

A wire harness mounting structure according to each embodiment will be described in detail below with reference to the drawings. Note that dimensional ratios in the drawings are exaggerated for convenience of the description and may be different from actual ratios.

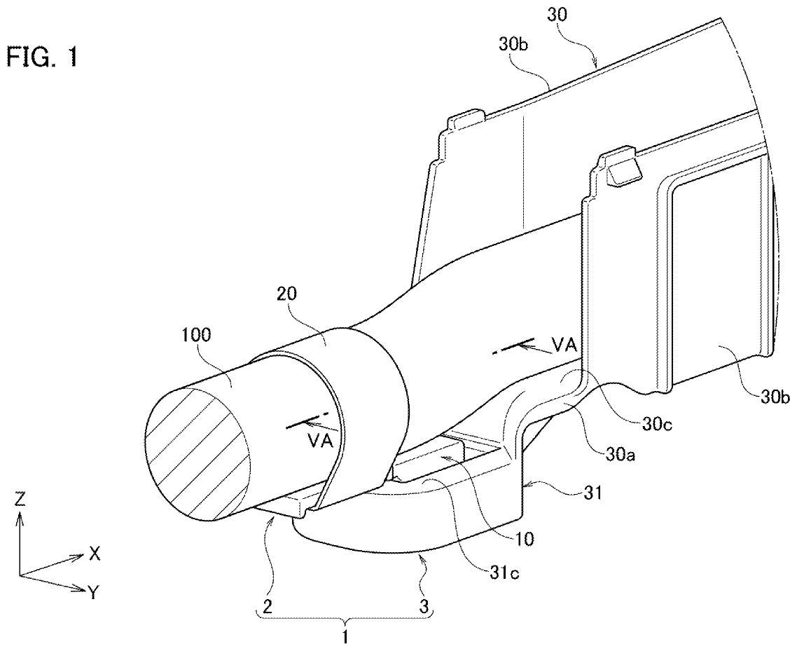

FIG. 1 is a perspective view of a wire harness mounting structure 1 according to an embodiment. The wire harness mounting structure 1 is a structure for mounting a wire harness 100 wired inside a vehicle such as an automobile to a prescribed installation position in the vehicle. In FIG. 1, a part of the wire harness 100 is schematically illustrated in a cylindrical shape.

The wire harness mounting structure 1 includes a clamp part 2 and a mounting part for mounting the wire harness 100 with the clamp part 2 therebetween. The mounting part is present in a wiring area of the wire harness 100 in a vehicle, and in the present embodiment, the mounting part is a protector 3 where at least a part thereof houses the wire harness 100.

The clamp part 2 is a unit or member used for mounting the wire harness 100 on the protector 3. In the present embodiment, the clamp part 2 is a unit having a clamp 10 and a clamp belt 20.

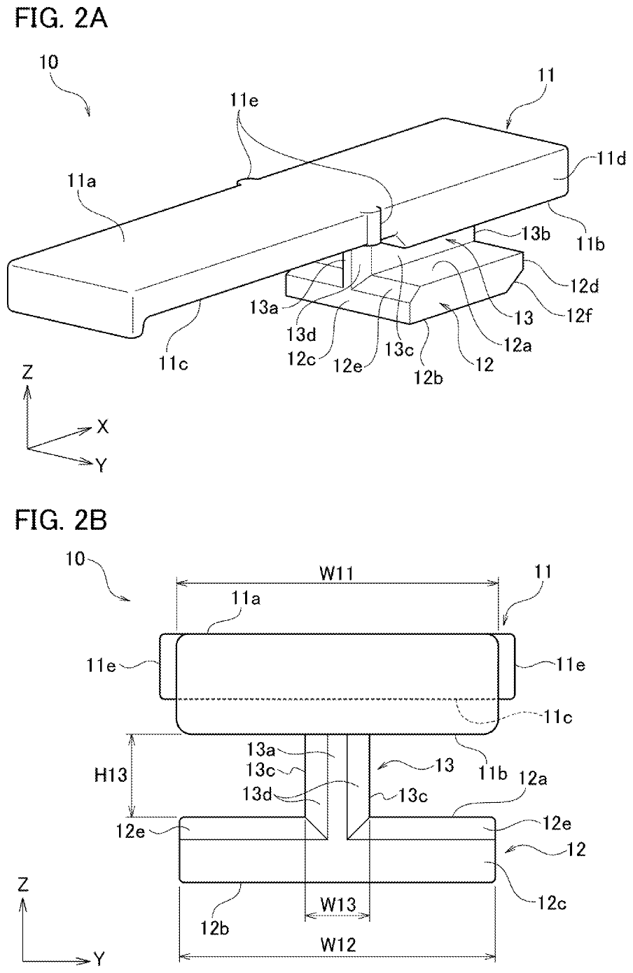

FIGS. 2A and 2B are diagrams relating to the clamp 10. FIG. 2A is a perspective view of the clamp 10. The clamp 10 is a member made of synthetic resin, for example, and has a body part 11, an engaging part 12, and a supporting part 13 integrally.

Hereinafter, in order to explain a shape or the like of each portion of the clamp part 2 and the protector 3, with reference to each portion of the clamp 10 as an example, each direction is defined as follows. A Z direction (hereinafter referred to as “height direction”) is a direction along a direction (hereinafter referred to as “facing direction”) in which the body part 11 and the engaging part 12 face each other. An X direction (hereinafter referred to as “length direction”) is perpendicular to the Z direction and approximately along an extension direction of the wire harness 100 when the clamp 10 holds the wire harness 100. A Y direction (hereinafter referred to as “width direction”) is perpendicular to both the X direction and the Z direction. In this case, FIG. 2B is a side view of the clamp 10 as viewed in the length direction.

The body part 11 directly holds the wire harness 100. In the present embodiment, a shape of the body part 11 is a flat plate shape in which the height direction is a thickness direction and the dimension in the length direction is larger than the dimension in the width direction as a whole. A first surface 11a of the body part 11 is one major planar surface and a surface on which the wire harness 100 is placed when the wire harness 100 is held. A second surface 11b of the body part 11 is the other major planar surface located on the opposite side of the first surface 11a in the height direction. Hereinafter, the dimension of the body part 11 in the width direction will be referred to as the width dimension W11.

The supporting part 13 is connected to the second surface 11b in a one-sided area of the body part 11 in the length direction, and the engaging part 12 supported by the supporting part 13 faces the second surface 11b. The clamp belt 20 is wound around the other one-sided area of the body part 11 in the length direction. As illustrated in FIG. 1, the clamp belt 20 holds the wire harness 100 for the clamp 10 by integrally winding the wire harness 100 placed on the first surface 11a and the body part 11. That is, in an entirety of the second surface 11b, the area to which the supporting part 13 is connected and the area to which the clamp belt 20 is wound are arranged in line in the length direction.

The area to which the clamp belt 20 is wound in the second surface 11b may be a groove 11c in order to prevent the wire harness 100 from falling off from the body part 11 due to the lateral slip of the clamp belt 20. In addition, on two side surfaces 11d extending in the length direction of the body part 11, at a boundary between the area to which the clamp belt 20 is wound and the area to which the supporting part 13 is connected, projections 11e may be disposed in order to prevent the clamp belt 20 from approaching the supporting part 13 side.

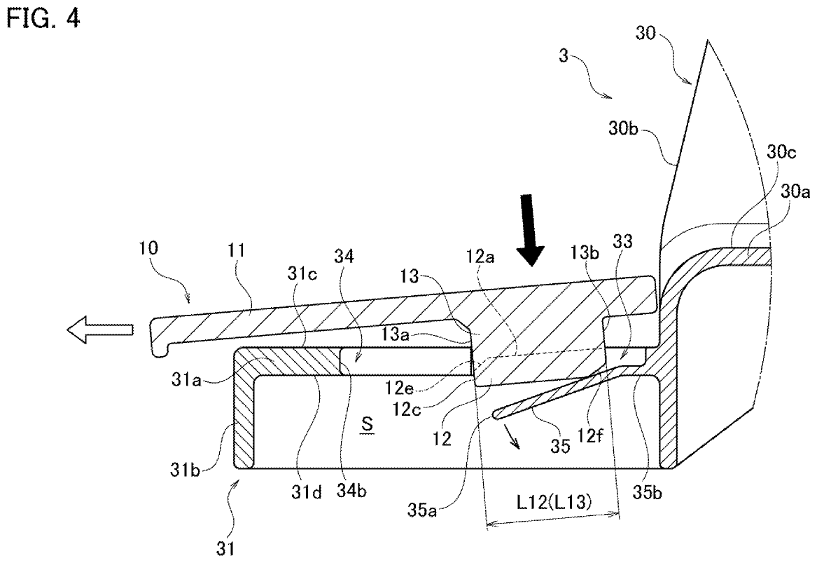

The engaging part 12 engages with a through hole 32 disposed in the protector 3 when the wire harness 100 is mounted on the protector 3. As described above, the engaging part 12 faces at least a part of the body part 11. In the present embodiment, a shape of the engaging part 12 is a flat plate shape having a first major planar surface 12a and a second major planar surface 12b positioned opposite to the first major planar surface 12a in the height direction and having a thickness direction as the height direction. The first major planar surface 12a is a surface on a side continuous with the supporting part 13. The second major planar surface 12b is a surface on a side where the engaging part enters a first through hole 33 when engaging with the through hole 32. Further, in the present embodiment, a plane shape of the engaging part 12 with respect to an XY plane parallel to the first major planar surface 12a and the second major planar surface 12b is a rectangular shape constituted by sides along either the length direction or the width direction. Hereinafter, the dimension of the engaging part 12 in the length direction will be referred to as the length dimension L12 (see FIG. 4), and the dimension of the engaging part 12 in the width direction will be referred to as the width dimension W12. In the present embodiment, the width dimension W12 of the engaging part 12 is equal to the width dimension W11 of the body part. Further, among two side surfaces extending in the width direction of the engaging part 12, a side surface on a side near the area to which the clamp belt 20 is wound in the body part 11 will be referred to as a first side surface 12c and a side surface far from the area will be referred to as a second side surface 12d.

A first tapered surface 12e may be disposed at a corner where the first major planar surface 12a and the first side surface 12c of the engaging part 12 meet to facilitate the entry of the engaging part 12 into the through hole 32, as described in detail below. Similarly, a second tapered surface 12f may be disposed at a corner where the second major planar surface 12b and the second side surface 12d meet.

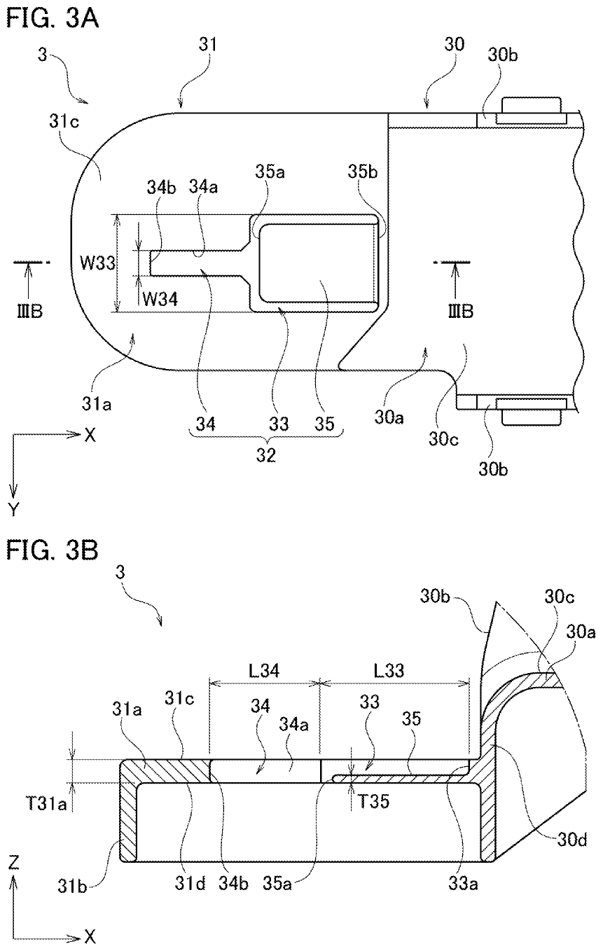

The supporting part 13 protrudes from the body part 11 and supports the engaging part 12. In the present embodiment, a shape of the supporting part 13 is a flat plate shape having a pair of side surfaces 13c in which the length dimension L13 (see FIG. 4) which is the dimension in the length direction is set equal to the length dimension L12 of the engaging part 12. Further, the height dimension H13 of the supporting part 13 in the height direction defines a distance between the body part 11 and the engaging part 12, and the height dimension H13 is set to be larger than the thickness dimension T31a (see FIG. 3B) of the through hole 32. In this case, a cross-sectional shape as a whole cut in an XY plane of the supporting part 13 is a rectangular shape constituted by sides along either the length direction or the width direction. A distance between the pair of side surfaces 13c, that is, the width dimension W13, which is the dimension of the supporting part 13 in the width direction, is set to be smaller than both the width dimension W11 of the body part 11 and the width dimension W12 of the engaging part 12. That is, the supporting part 13 is smaller than the engaging part 12 as viewed in the height direction. Further, in the present embodiment, the supporting part 13 is located at a center area of the body part 11 and the engaging part 12 in the width direction as illustrated in FIG. 2B. Hereinafter, among two end surfaces extending in the height direction of the supporting part 13, an end surface on a side close to the area to which the clamp belt 20 is wound of the body part 11 will be referred to as a first end surface 13a, and an end surface on a side far from the area will be referred to as a second end surface 13b.

At two corners where two major planar surfaces parallel to an XZ plane and the first end surface 13a of the supporting part 13 meet, tapered surfaces 13d may be disposed to facilitate the entry of the supporting part 13 into the through hole 32 as will be described in detail below.

There are no particular limitations on the clamp belt 20 as long as the belt can wind the wire harness 100 placed on the first surface 11a and the body part 11 integrally. The clamp part 2 may be a member in which the clamp 10 and the clamp belt 20 are integrated. In this case, for example, the clamp part 2 may be a member made of synthetic resin, and the clamp part 2 can be realized by having a configuration in which one end of the clamp belt 20 is made to be a fixed end and continuous with the clamp 10, and the other end of the clamp belt 20 is made to be a free end and can be freely connected to the clamp 10.

FIGS. 3A and 3B are diagrams relating to the protector 3. FIGS. 3A and 3B illustrate a portion of an entirety of the protector 3 including an entirety of a holding part 31 in which the through hole 32 is formed. FIG. 3A is a plan view of the protector 3 as viewed in an engagement direction when the engaging part 12 engages with the through hole 32 along the height direction. FIG. 3B is a cross-sectional view of the protector 3 which is taken along cross section IIIB-IIIB in FIG. 3A and cut so as to passes through a center position in the width direction of the through hole 32.

At least a part of the protector 3 houses and protects the wire harness 100. The protector 3 is made of synthetic resin, for example, and has a housing part 30, the holding part 31, and a cover (not illustrated).

The housing part 30 is long and narrow in accordance with a wiring path of the wire harness 100, and directly houses a part of the wire harness 100. The housing part 30 schematically has a bottom wall 30a and two side walls 30b facing each other. The bottom wall 30a has a bottom surface 30c as an inner surface, and the wire harness 100 is placed on the bottom surface 30c. Each of the two side walls 30b is continuous with a side end of the bottom wall 30a in an attitude perpendicular to the bottom wall 30a. Further, an area opposed to the bottom wall 30a of the housing part 30 is opened to the outside. By mounting the housing part 30 such that a cover (not illustrated) covers the opened area, the housing part 30, together with the cover, becomes a tubular body having an internal space in which the wire harness 100 is disposed.

The holding part 31 is positioned at at least one end of the protector 3 in an extension direction, and directly holds the wire harness 100 with the clamp part 2 therebetween. The holding part 31 schematically has a holding wall 31a and a reinforcing wall 31b. The holding wall 31a has a holding surface 31c, a back surface 31d which is an opposite surface of the holding surface 31c, and the through hole 32.

The holding surface 31c is a surface facing the wire harness 100 to be held, and is continuous with the bottom surface 30c of the housing part 30. In the present embodiment, as illustrated in FIG. 3B, the holding surface 31c is continuous with the bottom surface 30c through an intermediate wall 30d along the height direction, and is disposed at a height position that is one step lower than the bottom surface 30c in the height direction while being parallel with the bottom surface 30c.

The engaging part 12 of the clamp 10 engages with the through hole 32. The through hole 32 includes the first through hole 33, a second through hole 34, and an elastic piece 35.

The first through hole 33 has a shape and size sufficient to allow the engaging part 12 to pass therethrough, and passes through the holding wall 31a along the height direction. That is, the first through hole 33 is larger than the engaging part 12 as viewed in the height direction. In the present embodiment, an opening shape of the first through hole 33 is an approximate rectangular shape in which the length dimension L33, which is the dimension in the length direction, is set to be larger than the length dimension L12 of the engaging part 12, and the width dimension W33, which is the dimension in the width direction, is set to be larger than the width dimension W12 of the engaging part 12. Further, a position in the width direction where the first through hole 33 is formed in the holding part 31 may be a position that forms a symmetrical shape with respect to a center line passing through the center of the bottom surface 30c of the housing part 30 in the width direction, which is extended to the holding surface 31c.

The second through hole 34 has a shape and size sufficient to allow the supporting part 13 of the clamp 10 to pass therethrough although the engaging part 12 is not able to pass therethrough, and the second through hole 34 passes through the holding wall 31a along the height direction. That is, the second through hole 34 is smaller than the engaging part 12 and larger than the supporting part 13 as viewed in the height direction. In the present embodiment, an opening shape of the second through hole 34 is an approximate rectangular shape in which the length dimension L34 which is the dimension in the length direction is set to be smaller than the length dimension L12 of the engaging part 12 and the width dimension W34 which is the dimension in the width direction is set to be smaller than the width dimension W12 of the engaging part 12. Further, with respect to the rectangular shape, the length dimension L34 is larger than the length dimension L13 of the supporting part 13 and the width dimension W34 is larger than the width dimension W13 of the supporting part 13. In this case, a shape of the second through hole 34 is what is referred to as an slit shape. Further, a position in the width direction where the second through hole 34 is formed in the holding part 31 is a position where a center position of the second through hole 34 is aligned with a center position of the first through hole 33 in the width direction.

Further, the second through hole 34 is further away from the housing part 30 than the first through hole 33. As illustrated in FIGS. 3A and 3B, the first through hole 33 and the second through hole 34 are continuous along the length direction. Hereinafter, a portion of an opening edge 34a of the second through hole 34 which is located on a side opposite to a side where the second through hole 34 and the first through hole 33 are continuous in the length direction will be referred to as an “end edge 34b”.

The elastic piece 35 has a flat plate shape having a planar surface approximately parallel to the holding surface 31c and is arranged in the first through hole 33. A plane shape of the elastic piece 35 is an approximate rectangular shape having sides along the length direction or the width direction. The elastic piece 35 is supported by an opening edge 33a of the first through hole 33 at a cantilevered state, with a side facing the second through hole 34 as a free end 35a and a side opposite to the side facing the second through hole 34 as a fixed end 35b. That is, the elastic piece 35 is not in contact with the opening edge 33a except a portion where the fixed end 35b thereof is continuous, and is smaller than the first through hole 33 as viewed in the facing direction of the clamp 10. In order to make the elastic piece 35 have a thin plate shape that is easier to obtain elasticity than other walls of the holding part 31, the thickness dimension T35, which is the dimension in the Z direction, may be set to be smaller than the thickness dimension T31a of the holding wall 31a.

The reinforcing wall 31b is continuous with an outer peripheral end of the holding wall 31a and protrudes in a direction away from the back surface 31d along the height direction. The reinforcing wall 31b may function as a reinforcing part to maintain the strength of the holding wall 31a.

Next, a procedure for mounting the wire harness 100 using the wire harness mounting structure 1 will be described.

FIG. 4 is a cross-sectional view illustrating a state of the wire harness mounting structure 1 when the wire harness 100 is mounted on the protector 3. In FIG. 4, the protector 3 is illustrated in accordance with the drawing of FIG. 3B. Further, for convenience of explanation, in FIG. 4, the clamp 10 does not hold the wire harness 100.

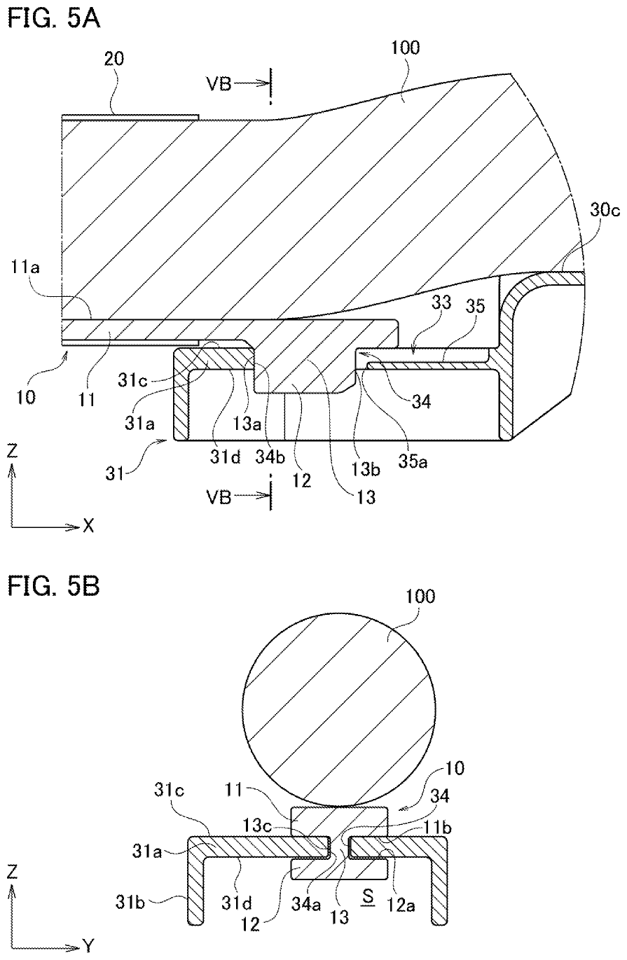

FIGS. 5A and 5B are diagrams of the wire harness mounting structure 1 after the wire harness 100 is mounted. FIG. 5A is a cross-sectional view of the wire harness mounting structure 1 which is taken along cross section VA-VA in FIG. 1. FIG. 5B is a cross-sectional view of the wire harness mounting structure 1 as viewed in the length direction which is taken along cross section VB-VB in FIG. 5A.

First, a worker mounts the clamp part 2 in the wire harness 100 in advance when the worker mounts the wire harness 100 on the protector 3. At this time, the worker can mount the clamp part 2 by integrally winding the clamp belt 20 around the wire harness 100 and the body part 11 while a prescribed portion of the wire harness 100 is brought into contact with the first surface 11a of the clamp 10.

Next, as illustrated in FIG. 4, the worker makes the engaging part 12 of the clamp 10 enter the first through hole 33 of the through hole 32 formed in advance in the holding part 31 of the protector 3 from the holding surface 31c side. A shape and size of the first through hole 33 are set such that the engaging part 12 can enter, but the elastic piece 35 is arranged in the first through hole 33. Therefore, the engaging part 12 continuously pushes the elastic piece 35 in a direction indicated by a black arrow in FIG. 4, and deforms the elastic piece 35 such that the free end 35a is gradually away from the back surface 31d side. The pushing of the elastic piece 35 by the engaging part 12 is performed to the extent that the first side surface 12c of the engaging part 12 can enter a space region S facing the back surface 31d.

As the engaging part 12 pushes the elastic piece 35, an attitude of the clamp 10 is tilted such that a side where the clamp belt 20 is wound is lower than a side where the supporting part 13 is continuous as illustrated in FIG. 4. Therefore, in the present embodiment, the through hole 32 of the protector 3 is formed in the holding part 31 positioned at an end of the protector 3 in the extension direction. According to this configuration, in particular, by setting the dimension of the clamp 10 in the length direction to be longer than the dimension of the holding part 31 in the length direction, it becomes difficult for an end of the clamp 10 in the length direction to interfere with the protector 3 even when an attitude of the clamp 10 is tilted as described above.

Next, the worker slides the clamp 10 in a direction along the length direction indicated by a white arrow in FIG. 4. A shape and size of the second through hole 34 are set such that the supporting part 13 can enter. Further, the second through hole 34 faces the free end 35a of the elastic piece 35 before deformation in the length direction. Therefore, when the clamp 10 slides, only the supporting part 13 enters the second through hole 34 and the engaging part 12 enters the space region S while facing the back surface 31d in the height direction.

In the present embodiment, the engaging part 12 has the first tapered surface 12e and the second tapered surface 12f. The first tapered surface 12e contacts a portion of the opening edge 33a of the first through hole 33 on a side where the second through hole 34 is continuous when the clamp 10 is slid, and this can guide the engaging part 12 toward the space region S. Similarly, the second tapered surface 12f contacts a surface of the elastic piece 35 when the clamp 10 is slid, and this can guide the engaging part 12 toward the space region S.

Further, in the present embodiment, the supporting part 13 has a tapered surface 13d. The tapered surface 13d contacts a corner where the opening edge 33a of the first through hole 33 and the opening edge 34a of the second through hole 34 meet when the clamp 10 is slid, and this can guide the supporting part 13 toward the second through hole 34.

When the sliding of the clamp 10 proceeds and an entirety of the supporting part 13 of the clamp 10 is housed in the second through hole 34, the elastic piece 35 in the first through hole 33 does not come into contact with any portion of the clamp 10. Therefore, as illustrated in FIG. 5A, a state of the elastic piece 35 returns to a state before deformation, and an operation of mounting the wire harness 100 on the protector 3 by means of the wire harness mounting structure 1 ends.

Next, effects of the wire harness mounting structure 1 will be described.

The wire harness mounting structure 1 includes the clamp 10 having the body part 11 for holding the wire harness 100, the engaging part 12 facing at least a portion of the body part 11, and the supporting part 13 that protrudes from the body part 11 and supports the engaging part 12. Further, the wire harness mounting structure 1 includes a mounting part having the through hole 32 with which the engaging part 12 is engaged. The supporting part 13 is smaller than the engaging part 12 as viewed in the height direction along the facing direction of the body part 11 and the engaging part 12. The through hole 32 has the first through hole 33 larger than the engaging part 12 as viewed in the height direction, and the second through hole 34 which is continuous with the first through hole 33 and is smaller than the engaging part 12 and is larger than the supporting part 13 as viewed in the height direction. Further, the through hole 32 has the elastic piece 35 which is arranged in the first through hole 33 and is supported by the opening edge 33a with the side facing the second through hole 34 as the free end 35a and the side opposite to the side facing the second through hole 34 as the fixed end 35b. The second through hole 34 has a shape in which only the supporting part 13 enters therein when the engaging part 12 enters the first through hole 33 while deforming the elastic piece 35.

In the examples using the above diagrams, the mounting part corresponds to the protector 3, and the height direction corresponds to the Z direction.

First, it is assumed that the engaging part 12 is pushed toward the first through hole 33 and enters the first through hole 33 while deforming the elastic piece 35, and continuously the clamp 10 is slid. At this time, since the free end 35a of the elastic piece 35 on the side facing the second through hole 34 is greatly deformed, only the supporting part 13 gradually enters the second through hole 34. At the same time, the engaging part 12 gradually enters the space region S on the opposite side from a space region where the body part 11 is located, with a portion of the mounting part where the second through hole 34 is formed as a reference. When an entirety of the supporting part 13 is housed in the second through hole 34, that is, when mounting of the wire harness 100 in the mounting part through the clamp part 2 ends (hereinafter simply referred to as “after the end of mounting”), the entirety of the engaging part 12 enters the space region S.

The supporting part 13 protrudes from the body part 11 and is smaller than the engaging part 12 as viewed in the height direction. Therefore, after the end of mounting, the body part 11 and the engaging part 12 of the clamp 10 face each other with a portion of the mounting part therebetween. More specifically, with reference to FIG. 5B, in the height direction which is illustrated as the Z direction in the diagram, the second surface 11b of the body part 11 and the first major planar surface 12a of the engaging part 12 face each other with the holding wall 31a which is a portion of the mounting part therebetween. As a result, the movement of the clamp 10 in the height direction relative to the mounting part is regulated.

Further, after the end of mounting, the supporting part 13 is interposed between portions facing each other of the opening edge 34a of the second through hole 34 in one direction of a planar surface perpendicular to the height direction. More specifically, with reference to FIG. 5B, the one direction here may correspond to, for example, the width direction indicated as the Y direction in FIG. 5B. In the width direction of the second through hole 34, the portions facing each other of the opening edge 34a face either one of the pair of side surfaces 13c of the supporting part 13. As a result, the movement of the clamp 10 in the width direction relative to the mounting part is regulated.

Furthermore, when an entirety of the supporting part 13 is housed in the second through hole 34, the elastic piece 35 is no longer in contact with any portion of the clamp 10, and thus a state thereof returns to a state before deformation. Therefore, after the end of mounting, the supporting part 13 is interposed between a portion of the opening edge 34a of the second through hole 34 and a portion of the elastic piece 35 in the other direction of the planar surface perpendicular to the height direction. More specifically, with reference to FIG. 5A, the other directions here may correspond to, for example, the length direction indicated as the X direction in the FIG. 5A. In the length direction of the second through hole 34, the first end surface 13a of the supporting part 13 faces the end edge 34b of the opening edge 34a, and the second end surface 13b of the supporting part 13 faces the free end 35a of the elastic piece 35. As a result, the movement of the clamp 10 in the length direction relative to the mounting part is regulated.

Therefore, according to the wire harness mounting structure 1, since the movement of the clamp 10 in any direction relative to the mounting part is regulated after the end of mounting, it is difficult for the clamp 10 to be detached from the mounting part, and accordingly the wire harness 100 can be made difficult to be detached from the mounting part. Meanwhile, after the end of mounting and after a worker breaks the elastic piece 35, and slides the engaging part 12 and the supporting part 13 to return them in the first through hole 33, for example, the clamp 10 can be detached from the mounting part. For example, even if a tensile load is applied to the wire harness 100 after the end of mounting, for example, the load is applied to the vicinity of the second through hole 34 where the supporting part 13 is located, while it is difficult for the load to be applied to the elastic piece 35 arranged in the first through hole 33. Therefore, since the elastic piece 35 is less likely to be broken unintentionally, as a result, the wire harness 100 can be made difficult to be detached from the mounting part.

As described above, according to the present embodiment, it is possible to provide the wire harness mounting structure 1 which makes it difficult to detach the wire harness 100 from a prescribed installation position.

Further, in the wire harness mounting structure 1, when the engaging part 12 engages with the through hole 32, a direction along a direction in which the first through hole 33 and the second through hole 34 are continuous is set to be the length direction. The width dimension W13 of the supporting part 13 in the width direction perpendicular to both the height direction and the length direction may be smaller than the width dimension W11 and the width dimension W12 of the body part 11 and the engaging part 12 in the width direction, and may be smaller than the length dimension L13 of the supporting part 13 in the length direction.

In the examples using the above diagrams, the length direction corresponds to the X direction, and the width direction corresponds to the Y direction.

According to the wire harness mounting structure 1, with respect to a shape of the first through hole 33 which allows the engaging part 12 to enter therein, it is possible to simply set a shape of the second through hole 34 which does not allow the engaging part 12 to enter therein while allowing the supporting part 13 to enter therein. Further, since the length dimension L13 of the supporting part 13 is larger than the width dimension W13 of the supporting part 13, the length dimension L13 can be set to be longer in order to reliably obtain the strength of the supporting part 13 required to support the engaging part 12 relative to the body part 11.

Further, in the wire harness mounting structure 1, the engaging part 12 may have a flat plate shape having the first major planar surface 12a continuous with the supporting part 13 and the second major planar surface 12b which is positioned on the opposite side of the first major planar surface 12a and is on a side where the engaging part enters the first through hole 33 when engaging with the through hole 32.

According to the wire harness mounting structure 1, a shape of the engaging part 12 is more simplified, which is advantageous in simplifying manufacturing processes of the clamp 10 and, consequently, in minimizing the manufacturing cost of the clamp 10.

A shape of the engaging part 12 may be shapes as exemplified below in addition to the flat plate shape having the first major planar surface 12a and the second major planar surface 12b as exemplified in FIGS. 2A and 2B.

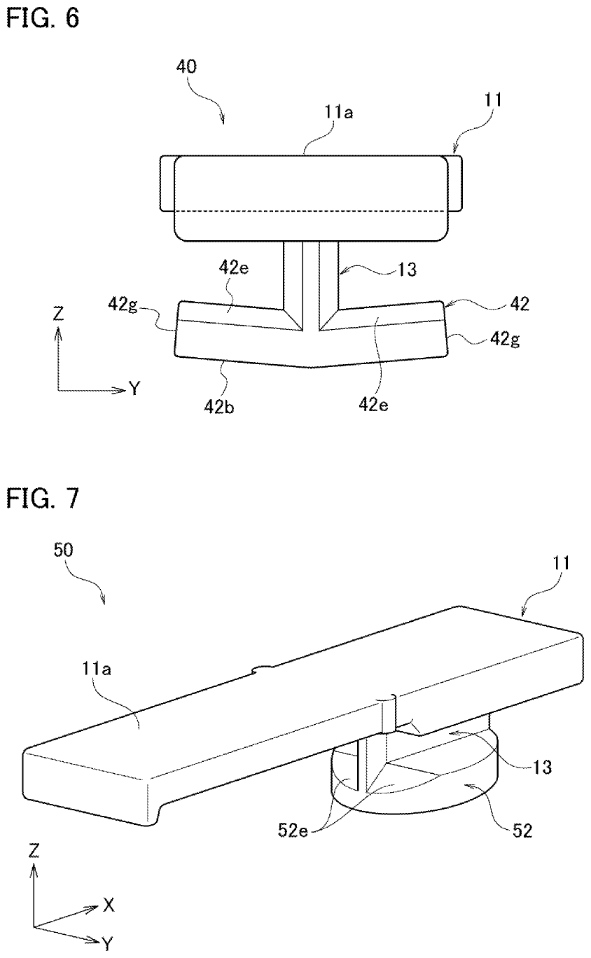

FIG. 6 is a side view of a clamp 40 having an engaging part 42 as a first modified example instead of the engaging part 12. In FIG. 6, the clamp 40 is illustrated in accordance with the drawing of FIG. 2B as viewed in the length direction. In the clamp 40, the same parts as those of the clamp 10 illustrated in FIG. 2B are denoted by the same reference numerals, and a description thereof will be omitted.

A side surface shape of the engaging part 42 as viewed in the length direction may be a shape in which the second major planar surface 42b is bent so as to be convex in a direction away from the body part 11. In this case, since a pair of side surfaces 42g along the length direction included in the engaging part 52 approach the body part 11 side, a side surface shape of a combination of the engaging part 42 and the supporting part 13 as viewed in the length direction becomes what is referred to as an arrow shape. Therefore, with reference to FIG. 5B, for example, after the end of mounting, while the second surface 11b of the body part 11 is brought into contact with the holding surface 31c of the holding wall 31a, one end of the pair of side surfaces 42g can abut the back surface 31d of the holding wall 31a with the entire engaging part 42 having elasticity. Therefore, according to this kind of engaging part 42, the clamp 40 can be stably connected to the mounting part. In addition, during a mounting operation of the wire harness 100, it is possible to suppress the engaging part 42 from being caught by another portion or to facilitate the engaging part 42 to enter the first through hole 33.

FIG. 7 is a perspective view of a clamp 50 having an engaging part 52 as a second modified example instead of the engaging part 12. In FIG. 7, the clamp 50 is illustrated in accordance with the drawing of FIG. 2A. In the clamp 50, the same parts as those of the clamp 10 illustrated in FIG. 2A are denoted by the same reference numerals, and a description thereof will be omitted.

For a plane shape with respect to the XY plane, the plane shape of the engaging part 12 illustrated in FIG. 2A and the like is a rectangular shape constituted by sides along either the length direction or the width direction. In contrast, a plane shape of the engaging part 52 illustrated in FIG. 7 is an elliptical shape. According to this kind of engaging part 52, the number of corners included in the engaging part 52 can be reduced, and therefore during a mounting operation of the wire harness 100, it is possible to suppress the engaging part 52 from being caught by another portion or to facilitate the engaging part 52 to enter the first through hole 33.

In order to further facilitate the engaging part 42 and the like to enter the through hole 32, for example, the engaging part 42 may have a first tapered surface 42e or the engaging part 52 may have a first tapered surface 52e in the same manner as the first tapered surface 12e of the engaging part 12.

Further, in the wire harness mounting structure 1, the mounting part may be the protector 3 where at least a part thereof houses the wire harness 100.

According to the wire harness mounting structure 1, it is assumed that the wire harness 100 is mounted at a prescribed installation position set in advance in the protector 3, and this can make it difficult to detach the wire harness 100 from the installation position.

The mounting part in the wire harness mounting structure 1 is not limited to the protector 3, but may be any wall disposed in advance in a vehicle such as an automobile.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A wire harness mounting structure comprising:
a clamp including a body part for holding a wire harness, an engaging part facing to at least a portion of the body part, and a supporting part that protrudes from the body part and supports the engaging part; and
a mounting part having a through hole with which the engaging part is engaged, wherein
the supporting part is smaller than the engaging part as viewed in a height direction along a facing direction of the body part and the engaging part,
the through hole includes:
a first through hole larger than the engaging part as viewed in the height direction;
a second through hole that is continuous with the first through hole and is smaller than the engaging part and is larger than the supporting part as viewed in the height direction; and
an elastic piece that is arranged in the first through hole and is supported by an opening edge with a side facing the second through hole as a free end and a side opposite to the side facing the second through hole as a fixed end, and
the second through hole has a shape in which only the supporting part enters therein when the engaging part enters the first through hole while deforming the elastic piece.

2. The wire harness mounting structure according to claim 1,
when the engaging part engages with the through hole, a direction along a direction in which the first through hole and the second through hole are continuous is set to be a length direction, and
a width dimension of the supporting part in a width direction perpendicular to both the height direction and the length direction is smaller than a width dimension of the body part and a width dimension of the engaging part in the width direction, and is smaller than a length dimension of the supporting part in the length direction.

3. The wire harness mounting structure according to claim 1, wherein
the engaging part has a flat plate shape having a first major planar surface continuous with the supporting part and a second major planar surface that is position on an opposite side of the first major planar surface and is on a side where the engaging part enters the first through hole when engaging with the through hole.

4. The wire harness mounting structure according to claim 1, wherein
the mounting part is a protector where at least a part thereof houses the wire harness.
